(19) United States
(12) Patent Application Publication
(10) Pub. No.: US 2013/0262186 A1
(43) Pub. Date: Oct. 3, 2013

(54) Apparatus Pertaining to Characterizing Real Estate Listing Prices

(71) Applicant: Leap Real Estate Systems, Chicago, IL (US)

(72) Inventors: Paul E. Lazarre, Chicago, IL (US); Craig Sparling, Chicago, IL (US); Charles Carlin, Chicago, IL (US)

(21) Appl. No.: 13/854,466

(22) Filed: Apr. 1, 2013

Related U.S. Application Data
(60) Provisional application No. 61/618,228, filed on Mar. 30, 2012.
(60) Provisional application No. 61/640,167, filed on Apr. 30, 2012.

(51) Int. Cl. G06Q 30/02; G06Q 50/16

(52) U.S. Cl. CPC G06Q 30/0283; G06Q 50/16
USPC 705/7.35

(57) ABSTRACT

A control circuit accesses information regarding at least (1) listing events for real estate offerings other than a given real estate offering (for which the control circuit is assessing a corresponding listing price) and (2) offering particulars for real estate offerings other than the given real estate offering. The control circuit compares that information with listing events and offering particulars of the given real estate offering to generate a plurality of corresponding relative evaluation metrics for the given real estate offering and then aggregates that plurality of corresponding relative evaluation metrics to generate a corresponding characterization of the listing price for the given real estate offering.

### RELATED APPLICATION(S)

This application claims the benefit of U.S. Provisional application No. 61/618,228, filed Mar. 30, 2012 and entitled APPARATUS AND METHOD PERTAINING TO REAL ESTATE MARKETING, which is incorporated by reference in its entirety herein.

This application also claims the benefit of U.S. Provisional application No. 61/640,167, filed Apr. 30, 2012 and entitled APPARATUS AND METHOD PERTAINING TO REAL ESTATE MARKETING, which is incorporated by reference in its entirety herein.

This application is related to co-pending and co-owned U.S. patent application Ser. No. 12/845,490, entitled LEVERAGED USAGE OF INFORMATION REGARDING REAL ESTATE OFFERINGS and filed Jul. 28, 2010, which is incorporated by reference in its entirety herein.

### COPYRIGHT

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This invention relates generally to the offering of real estate for purchase.

### BACKGROUND

The offering for sale of real estate comprises a long-established area of endeavor. Generally speaking, this activity involves providing information to one or more potential purchasers regarding the availability of a given parcel of real estate. Amongst a myriad of possibilities this information often at least includes a proposed sales price. In many cases the party looking to sell the real estate contracts with a representative or agent (such as a realtor or real estate broker) to seek out worthy potential purchasers and to provide such information to such parties.

Problems exist with respect to setting an asking price for a given real estate parcel. Generally speaking, price should reflect demand. Assessing “demand,” however, is challenging even for real estate professionals. Furthermore, understanding demand alone does not necessarily mean that one can immediately correlate that understanding to “the” appropriate asking price for a given real estate parcel. How quickly the seller wishes to sell their property can influence as well determination that a particular listing price is too low, too high, or appropriate in context. Such confusion and uncertainty, in turn, can lead to inappropriately high (or low) initial asking prices. This confusion and uncertainty often only gets worse as time passes and a given property fails to sell within some hoped-for time frame.

### BRIEF DESCRIPTION OF THE DRAWINGS

The above needs are at least partially met through provision of the apparatus pertaining to characterizing real estate listing prices described in the following detailed description, particularly when studied in conjunction with the drawings, wherein:

FIG. 1 comprises a block diagram as configured in accordance with various embodiments of the invention;

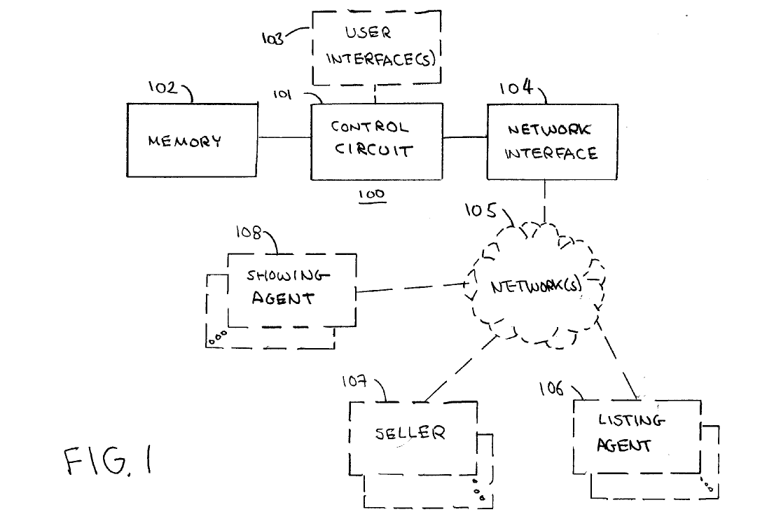

FIG. 2 comprises a flow diagram as configured in accordance with various embodiments of the invention; and

FIG. 3 comprises a screen shot as configured in accordance with various embodiments of the invention.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a control circuit accesses information regarding at least (1) listing events for real estate offerings other than a given real estate offering (for which the control circuit is assessing a corresponding listing price) and (2) offering particulars for real estate offerings other than the given real estate offering. The control circuit compares that information with listing events and offering particulars of the given real estate offering to generate a plurality of corresponding relative evaluation metrics for the given real estate offering and then aggregates that plurality of corresponding relative evaluation metrics to generate a corresponding characterization of the listing price for the given real estate offering.

By one approach the aforementioned aggregation of a plurality of corresponding relative evaluation metrics can comprise weighting relative contributions of various ones of the corresponding relative evaluation metrics differently from one another. In such a case, these teachings will also accommodate automatically modifying (over time, for example), the weighting of one or more of these relative contributions. Such modifications can in turn be based, for example, upon automatically repeating (for example, from time to time) one or more of the foregoing actions for the same (and/or other) real estate offering to determine when a particular relative evaluation metric may be insufficiently, or unduly, weighted.

If desired, these teachings will further include transmitting the foregoing characterization of the listing price to one or more interested parties. These interested parties can include, for example, one or more sellers of the given real estate offering and/or the listing real estate agent for the given real estate offering.

So configured, a given listing price (however determined) for a given real estate offering can be vetted against past, near-term, and current market metrics to develop a quantified view of how appropriate that given listing price is for the relevant market. That information, in turn, can help the seller/listing agent understand and recognize that it may be appropriate to reduce the listing price. (Bidding amongst potential purchasers will often resolve the situation that attends a listing price that is too low for present market conditions.)

These and other benefits may become clearer upon making a thorough review and study of the following detailed description. Referring now to the drawings, an apparatus 100 that is compatible with many of these teachings will now be presented.

In this illustrative example the apparatus 100 includes a control circuit 101 that operably couples to a memory 102 and optionally, if desired, to one or more user interfaces 103. Such a control circuit 101 can comprise a fixed-purpose hard-wired platform or can comprise a partially or wholly programmable platform. It will also be understood that this control circuit 101 can comprise a distributed platform that includes, for example, a plurality of interconnected but nevertheless standalone computers (such as, for example, a plurality of personal and/or server computers). These architectural options are well known and understood in the art and require no further description here. This control circuit 101 is configured (for example, by using corresponding programming as will be well understood by those skilled in the art) to carry out one or more of the steps, actions, and/or functions described herein.

The memory 102 may be integral to the control circuit 101 or can be physically discrete (in whole or in part) from the control circuit 101 as desired. This memory 102 can also be local with respect to the control circuit 101 (where, for example, both share a common circuit board, chassis, power supply, and/or housing) or can be partially or wholly remote with respect to the control circuit 101 (where, for example, the memory 102 is physically located in another facility, metropolitan area, or even country as compared to the control circuit 101).

This memory 102 can serve, for example, to non-transitorily store the computer instructions that, when executed by the control circuit 101, cause the control circuit 101 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).) In lieu of the foregoing or in combination therewith this memory 102 can also serve to store various items of information as describe herein.

The user interface 103 can comprise any of a variety of user-input mechanisms (such as, but not limited to, keyboards and keypads, cursor-control devices, touch-sensitive displays, speech-recognition interfaces, gesture-recognition interfaces, and so forth) and/or user-output mechanisms (such as, but not limited to, visual displays, audio transducers, printers, and so forth) to facilitate receiving information and/or instructions from a user and/or providing information to a user.

By one approach the control circuit 101 can also operably couple to one or more network interfaces 104 that couple, in turn, to one or more networks 105. Various networks are known in the art and include a variety of intranets and extranets such as, but not limited to, the Internet. So configured, the control circuit 101 can communicate, at least from time to time, with the computing platforms of a variety of relevant entities including but not limited to one or more listing agents 106 and/or sellers 107 of corresponding real estate offerings. These teachings will also accommodate communications with one or more showing agents 108 as described herein.

Such a network interface 104 can also facilitate communicatively coupling the control circuit 101 to other useful information sources as well as desired. Examples in these regards include, but are not limited to, a lock-box system interface, a showing system, a multiple listing system(s) for property information, and/or one or more consumer-facing web sites (e.g., a realtor site, Zillow, an MLS consumer portal) that support virtual showings.

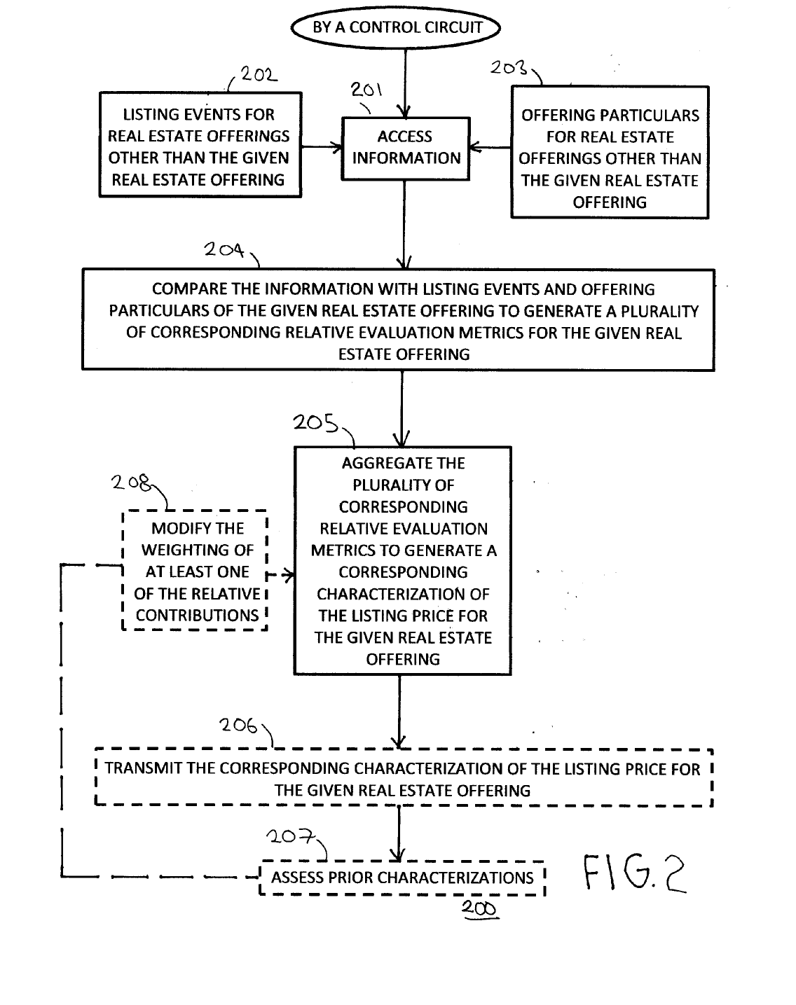

Referring to FIG. 2 such a control circuit 101 can be configured (using, for example, corresponding programming) to carry out the illustrated process 200. Per this process 200 the control circuit 101 accesses information at 201 such as information stored in the aforementioned memory 102. By one approach this information includes listing events 202 for a plurality of real estate offerings (other than a given real estate offering that is of present interest). The specific listing events 202 that serve in these regards can vary from one application setting to another. Generally speaking, “listing events” are events that pertain to a real estate listing. Examples in these regards include, but are not limited to, the time that a given real estate offering has been on the market (such as the duration of a current listing and/or an aggregation of listing durations when a given real estate offering has been listed by a succession of two or more different listing agents), the time since a last listing price reduction for a given real estate offering, a number of in-person showings for a given real estate offering (such as the total number of in-person showings during an entire listing period for the offering and/or only the total number of in-person showings that have occurred during some specified period of time such as a during a last thirty-day period), a number of virtual showings for a given real estate offering (i.e., browser-based virtual tours provided to at least some degree of having accessed a given number of images/pages), a number of offers to purchase (including, for example, both accepted as well as refused or countered offers), and sales closings to note but a few examples in these regards.

The accessed information can also include, if desired, the offering particulars for the plurality of real estate offerings other than the given real estate offering. “Offering particulars” refers generally to the representative specifics of the real estate offerings. Examples in these regards include but are not limited to square footage, age, the listing price, and listing price reductions. Other examples include such things as the number of bedrooms and bathrooms, the availability of central air conditioning and central heating, fireplaces, garage stalls, perimeter fencing, driveway materials, kitchen amenities, upgraded fixtures and accoutrements, neighborhood specifics, proximity to shopping, schools, and/or transportation, and so forth.

By one approach such information can be gleaned from resources such as on-line multiple listing services and/or from the property owner via an interview or other information-extraction process of choice. By another approach, in lieu of the foregoing and/or in combination therewith such information can be obtained, at least in part, by the efforts of associates and/or contractors of the enterprise that operates the apparatus 100.

At 204 the control circuit 101 compares the accessed information with listing events and offering particulars of the given real estate offering of interest to thereby generate a plurality of corresponding relative evaluation metrics for the given real estate offering. Examples of useful relative evaluation metrics include, but are not limited to:
an average number of showings for the real estate offerings as compared to the number of showings for the given real estate offering of interest;
a square-footage ranking (to compare, for example, the size of the given real estate offering of interest to other real estate offerings and/or to compare the price-per-square-foot metric for the given real estate offering of interest to other real estate offerings;
a listing price rank amongst active listing to represent relative position of the given real estate offering of interest by price as compared to other available real estate offerings;
a listing price rank amongst closed listings to represent relative position of the given real estate offering of interest by price as compared to other real estate offerings that have successfully closed (for example, within the last month, the last three months, or some other period of interest);
a comparison of listing price reduction timings to represent, for example, a comparison of how long it has been since the last price reduction for the given real estate offering of interest as compared to an average period of time between price reductions for other real estate offerings of interest; and
a comparison of time on market durations;
   to note but a few examples in these regards. (It should be noted that when making comparisons between the real estate offering of interest and other real estate offerings, for many application settings it will be useful to use other real estate offerings that are comparable to the real estate offering of interest. This concept of comparability is generally well understood in the art and needs no further elaboration here. If desired, the pool of comparable real estate offerings can be further restricted to offerings that are in the same neighborhood as the real estate offering of interest.)

Although certainly useful and interesting in and of themselves, at 205 the control circuit 101 aggregates the aforementioned plurality of corresponding relative evaluation metrics to generate a corresponding characterization of the listing price for the given real estate offering of interest (where the listing price can comprise a live listing price (i.e., a currently specified sales price in a legally-available listing of the real estate) or, if desired, a candidate listing price (such as possible listing price for a property about to be listed or a possible new listing price for an already-listed property). This characterization can represent, for example, the appropriateness and inappropriateness of that listing price for the given real estate offering. By one approach this determination regarding appropriateness and inappropriateness of the listing price can be based, at least in part, on a seller's evinced preference regarding selling quickly and maximizing the sales price (these two goals usually being generally opposed to one another in real estate).

Such a characterization can assume a variety of forms. By one approach, for example, the characterization can comprise a specific value in a range of values that represent the appropriateness of the listing price for the given real estate offering. The utilized range can vary as desired and might comprise, for example, a range from 1 to 10 or from 1 to 100, with any number of other ranges (and range metrics) being possible.

By one approach, the aggregation of the various relative evaluation metrics can presume and treat each relative evaluation metric as each being of equal importance to one another. These teachings will also accommodate, however, using weighting to permit the relative contribution of various ones of the relative evaluation metrics to be different from one another as appropriate. As one illustrative approach in these regards, and without intending any limitations by way of the specificity of this example, time on market can represent ten percent of the aggregated characterization, time since a reduction in price (or the initial listing) can represent twenty percent of the aggregated characterization, a showing ratio (for example, average showings per week for the real estate offering in question as compared to average showings per week for other offerings in the relevant neighborhood) can represent thirty percent of the aggregated characterization, price ranking with respect to active listing can represent fifteen percent of the aggregated characterization, price ranking with respect to closed listings can represent fifteen percent of the aggregated characterization, and a price-per-square-foot ranking can represent ten percent of the aggregated characterization.

An example equation for a calculating the pricing characterization may be a linear regression equation as follows:

Yᵢ=β₀+β₁Xᵢ₁+β₂Xᵢ₂+ . . . +βₚXᵢₚ+εᵢ

where i=1, . . . , n, Y=the predicted demand value, β=the parameter estimators, X=the corresponding independent variables, and ε represents an error term. Non-linear and/or tree-based regressions could also be used to determine a most effective predictor of the data (for example, as determined by either a hold-out population or back-testing).

These teachings will accommodate beginning with seed variables with one or more of the relevant variables. For example, an eighty percent threshold may initially serve as a line of delineation for high time on market while ninety-five percent may serve as a line of delineation for maximum time on market. As further examples, eighty percent may serve as a line of delineation for high time since reduction and ninety-five percent can similarly serve for a maximum time since reduction variable.

So configured, this metricized characterization of the appropriateness of a current listing price for a given real estate offering of interest can help a seller, listing agent, or other interested party to determine whether maintaining the current listing price appropriately serves the seller's interests or whether, for example, a current reduction in the listing price will better serve the seller's interests.

If desired, at 206 the control circuit 101 can optionally transmit the corresponding characterization of the listing price for the given real estate offering to one or more pre-identified parties of interest. Such parties can include, for example, a listing real estate agent for the given real estate offering and/or one or more of the sellers of the given real estate offering. Numerous permutations in these regards are possible. For example, by one approach the control circuit 101 first transmits the information to the listing agent. Then, following some predetermined period of time (such as, for example, one day, three days, one week, or some other duration of interest), the control circuit 101 automatically transmits the information to the seller unless, for example, the listing agent or other authorized party instructs the control circuit 101 otherwise.

The transmission itself can be, for example, via an email that contains the information, either as a part of the email itself or as an attachments. As another approach, in lieu of the foregoing or in combination therewith, the transmission can comprise a message (such as an email, a Tweet, and so forth) that includes a link to a webpage where the recipient can view the information.

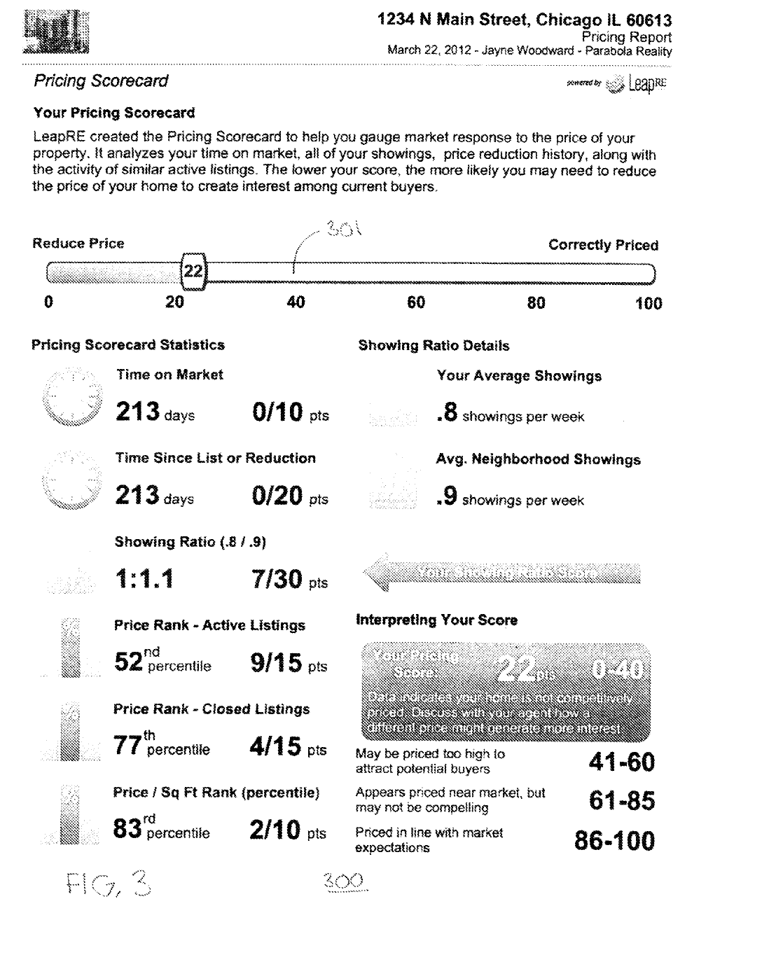

FIG. 3 provides an example of such a report 300. It will be understood that the specifics of this example report 300 are intended to serve an illustrative purpose and are not to be taken as suggesting any particular limitations in these regards.

This report 300 (which might be called a “pricing scorecard” to help the recipient understand the general context and substance of the information provided) can provide information that identifies the relevant real estate offering, the date, and the listing agent and/or seller. The pricing characterization 301 in this example comprises a scale ranging from “0” to “100,” with the left side of the scale leaning more towards a characterization that a price reduction is appropriate and the right side of the scale leaning more towards a characterization that the present price is appropriate. Other ranges could of course serve in these same regards, such a range of “0” to “10” or “0” to “85” if desired.

In this particular example the pricing characterization represents a score of “22” on the foregoing scale and hence represents to some significant degree that the current listing price for the relevant real estate offering is not appropriately priced and should, instead, be the subject of a price reduction.

In this example the report 300 provides other information as well. On the left side of the report 300, below the pricing characterization 301, are details regarding the various relative evaluation metrics as well as their relative weighting. This report 300 indicates, for example, that the time on market (identified as 213 days) evaluation metric is, relatively speaking, too long and hence receives 0 points out of an available 10 points. The showing ratio (with details regarding the numerator and denominator of this ratio being highlighted on the right side of the report 300) is 1 to 1.1, however, and hence receives a somewhat better score of 7 points out of 30 available points for this relative evaluation metric. (Summing the awarded points for these various relative evaluation metrics yields the score of “22” as the aggregated pricing characterization 301).

In addition to presenting the pricing characterization 301 and details regarding the various relative evaluation metrics that are the foundation of the pricing characterization 301, this report 300 also provides information in the lower right-hand corner to help the reader interpret the pricing characterization 301 and thereby better inform the reader's decision-making process regarding applying this information to their own circumstances, goals, and expectations.

While the particular relative evaluation metrics selected for use by a given user may be highly relevant for a given market, it is possible that the relative importance of any particular such evaluation metric can vary over time. That the importance of a given evaluation metric might have changed may, or may not, be evident and/or intuitive to the user.

To accommodate such changing circumstances, and referring again to FIG. 2, at 207 this process 100 will accommodate accessing prior characterizations and then, at 208, modifying the weighting of at least one of the relative contributions to the aggregation step 205. For example, the control circuit 101 can be configured to automatically re-access the available information, re-compare the information, and then re-aggregate the plurality of corresponding relative evaluation metrics from time to time (such as once a week, once a month, once an annual quarter, or per any other periodic or anecdotal schedule as may be preferred) to thereby generate a plurality of corresponding characteristics of listing prices for any number of real estate offerings (including the given real estate offering of interest) over time to thereby inform the foregoing modifications. Using such an approach, the particular equation applied at any given time can be automatically tweaked on occasion to better accord with market performance (even when such tweaking may appear, on its face to the informed user, as being counter intuitive). Any number of known optimization methodologies that rely, in part or in whole, upon iterative automatic changes to one or more parameters of a given equation, can readily serve in these regards.

These teachings are highly flexible in practice. For example, any number of different relative evaluation metrics can serve to best reflect a particular market. As another example, these teachings can be readily expanded upon to provide deeper service and functionality. For example, by one approach the control circuit 101 can be further configured to access further information stored in the memory 102 regarding (1) unlisted real estate offerings that were last sold more than a predetermined amount of time ago (such as, for example, three, five, or seven years ago or some other duration of relevance) and (2) real estate offerings that were previously listed but that are now unlisted without having been sold. The control circuit 101 can then use this further information to automatically develop at least one list of listing leads that a realtor can leverage to inform potential sellers of their selling opportunities.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

We claim:

1. An apparatus to automatically characterize a listing price for a given real estate offering comprising:
a memory;
a network interface;
a control circuit operably coupled to the memory and the network interface and configured to:
access information stored in the memory regarding:
listing events for real estate offerings other than the given real estate offering;
offering particulars for real estate offerings other than the given real estate offering;
compare the information with listing events and offering particulars of the given real estate offering to generate a plurality of corresponding relative evaluation metrics for the given real estate offering;
aggregate the plurality of corresponding relative evaluation metrics to generate a corresponding characterization of the listing price for the given real estate offering.

2. The apparatus of claim 1 wherein the control circuit is configured to automatically re-access the information, re-compare the information, and re-aggregate the plurality of corresponding relative evaluation metrics from time to time to thereby generate a plurality of corresponding characterizations of listing prices for the given real estate offering over time as corresponds to a given listing of the given real estate offering.

3. The apparatus of claim 1 wherein the listing events include at least one of:
time on market;
time since a last listing price reduction;
in-person showings;
virtual showings;
offers to purchase;
sales closings.

4. The apparatus of claim 1 wherein the offering particulars include at least one of:
square footage;
listing price;
listing price reductions.

5. The apparatus of claim 1 wherein the control circuit is configured to compare the information with listing events and offering particulars of the given real estate offering to generate a plurality of corresponding relative evaluation metrics for the given real estate offering, at least in part, by generating relative evaluation metrics for at least one of:
an average number of showings;
a square-footage ranking;
listing price rank amongst active listings;
listing price rank amongst closed listings;
a comparison of listing price reduction timings;
a comparison of time on market durations.

6. The apparatus of claim 1 wherein the control circuit is configured to aggregate the plurality of corresponding relative evaluation metrics, at least in part, by weighting relative contributions of various ones of the corresponding relative evaluation metrics differently from one another.

7. The apparatus of claim 6 wherein the control circuit is further configured to:
automatically modify the weighting of at least one of the relative contributions.

8. The apparatus of claim 1 wherein the control circuit is further configured to:
transmit the corresponding characterization of the listing price for the given real estate offering to at least one of:
a listing real estate agent for the given real estate offering;
at least one seller of the given real estate offering.

9. The apparatus of claim 1 wherein the corresponding characterization of the listing price comprises a characterization as regards the appropriateness and inappropriateness of the listing price for the given real estate offering.

10. The apparatus of claim 9 wherein the characterization as regards the appropriateness and inappropriateness of the listing price is based, at least in part, on a seller's preference regarding selling quickly and maximizing a sales price.

11. The apparatus of claim 9 wherein the characterization comprises a specific value in a range of values that represent appropriateness of the listing price for the given real estate offering.

12. The apparatus of claim 1 wherein the listing price comprises at least one of:
a live listing price; and
a candidate listing price.

13. The apparatus of claim 1 wherein the control circuit is further configured to:
access further information stored in the memory regarding:
unlisted real estate offerings that were last sold more than a predetermined amount of time ago;
real estate offerings that were previously listed but are now unlisted without having been sold;
use the further information to automatically develop at least one list of listing leads.
